(19) United States
(12) Patent Application Publication
(10) Pub. No.: US 2008/0016546 A1
(43) Pub. Date: Jan. 17, 2008

(54) DYNAMIC PROFILE ACCESS CONTROL

(76) Inventors: TONG L. LI, Cary, NC (US); Li Dai, Shanghai (CN); Harold Moss, Danvers, MA (US); Glen E. Salmon, Amesbury, MA (US); Zhen Zhou, Shanghai PuDong New Area (CN)

Correspondence Address: HOFFMAN, WARNICK & D'ALESSANDRO LLC, 75 STATE ST, 14TH FLOOR, ALBANY, NY, 12207, US

(21) Appl. No.: 11/457,222

(22) Filed: Jul. 13, 2006

(51) Int. Cl. H04L 9/00

(52) U.S. Cl. 726/1

(57) ABSTRACT

Dynamic profile access control. Access control is provided by dynamically forming user groups according to a hierarchical organization structure and policy rules specified for organizational resources. The dynamically formed user groups are treated as the subject in a common access control component and are used to grant permission to or revoke permission to individual or groups of elements.

### TECHNICAL FIELD

This disclosure relates generally to access control, and more specifically to dynamically forming user groups from an organizational hierarchy and using the user groups to grant permissions to protected resources.

### BACKGROUND

In a typical access control scenario there are resources that have restricted permissions such that there are some groups of people who will have access to the resources and other groups of people who will not have access to the resources. For many business organizations controlling access to certain resources is a continuing challenge. Typically, business organizations will need to assign access control relative to a specific business context, focusing specifically on core concepts of the business. That results in the need to extend the security capabilities that are common in web based architectures to encompass specific business objects affected by varying business rules. Often these business rules are further impacted by hierarchal structures such as organizational entities, as well as group and physical asset structures. One such situation would be transparency as it relates to a hierarchal structure where both upstream and downstream access to a resource may be limited by a specific business rule set. For example, John Smith, a low level manager in a business organization, may see information (e.g. resources owned by other people) three levels above him. Assume that Lisa is John's manager, then John may see resources that Lisa owns. Furthermore, if Lisa's manager is Tyler, then John can also see Tyler's resources. This continues until the distance between John and the person above him reaches three levels.

Typically, in such a scenario, business organizations will provide access control to protected resources by forming user groups of people that can have access to the resources. As a result, members of the user groups will have permission to access the resources while people who are not members will not have access. Members of the user groups are generally dictated by the hierarchical structure of the business organization and by the specific business rules. In the above example, according to the hierarchical structure and business rules, low level managers like John Smith will have access to certain resources three levels up.

Currently, almost all modern access control tools utilize concepts of users and user groups. For the most part, these access control tools treat users and user groups identical. That is, once the users and user groups are defined, they become the subjects and can be used to grant and revoke permissions to and from. These access control tools do have their drawbacks. For instance, many of the tools assume that the formed user groups are static or will not change. However, that is not a reasonable assumption given that change is a constant in many business organizations. Therefore, if a person leaves a user group then they have to be manually removed from the group. Likewise, if a person joins a user group then they have to be manually added to the group. Manually changing user groups is problematic from a consistency point of view. For example, if one employee has been removed from an organization and an administrator has not had a chance to remove him or her from the user group, then that person will continue to have access to various resources.

If the user groups could be created dynamically as opposed to statically, then it is believed that these dynamically created user groups in conjunction with an unchanging policy would result in none of the above-mentioned problems. As a result, once a person is removed from an organization, his or her permission would be removed automatically since he or she would not be in the dynamically formed user groups.

Therefore, there is a need for an approach that will facilitate improved access control for business organization scenarios and extend beyond using static methodologies to form user groups. Dynamically forming user groups and using the groups to grant permissions to protected resources would provide an access control approach that results in better security and requires less amount of oversight. Other benefits from using such an approach is that the organization reporting structure pattern could be more closely followed and there would be a reduction in the number of policies which would improve the performance of access control as a whole.

### SUMMARY

In one embodiment, there is a method for providing dynamic profile access control. In this embodiment, a policy is obtained that specifies access permissions to a protected resource within an organization. Also, a hierarchical structure is retrieved that describes associations between members in the organization. A user group is dynamically formed based on the obtained policy and retrieved hierarchical structure. Then the dynamically formed user group is used to grant access permissions to the protected resource.

In another embodiment, there is a dynamic profile access control tool for use in a computer system that controls access to a protected resource. The tool comprises a policy repository containing rules that specify access permissions to a protected resource within an organization. A hierarchical structure repository is configured to store a hierarchical structure that describes associations between members in the organization. A dynamic user group formation component is configured to obtain the policy from the policy repository and the hierarchical structure from the hierarchical structure repository and dynamically form a user group based on the policy and hierarchical structure. A permissions component is configured to use the dynamic user group to grant access permissions to the protected resource.

In a third embodiment, there is a computer readable medium containing computer instructions for providing dynamic profile access control within a computer system that controls access to a protected resource. In this embodiment, the computer instructions include obtaining a policy that specifies access permissions to a protected resource within an organization; retrieving a hierarchical structure that describes associations between members in the organization; dynamically forming a user group based on the obtained policy and retrieved hierarchical structure; and using the dynamically formed user group to grant access permissions to the protected resource.

In yet another embodiment, there is a method for deploying a dynamic profile access control tool for use in a computer system that controls access to a protected resource. In this embodiment, a computer infrastructure is provided and is operable to obtain a policy that specifies access permissions to a protected resource within an organization; retrieve a hierarchical structure that describes associations between members in the organization; dynamically form a user group based on the obtained policy and retrieved hierarchical structure; and use the dynamically formed user group to grant access permissions to the protected resource.

Therefore, this disclosure provides a method, system, and program product for deploying an application for using a dynamic profile access control tool in a computer system to control access to a protected resource.

### BRIEF DESCRIPTION OF THE DRAWINGS

FIG. 1 shows a high-level component architecture diagram of a dynamic profile access control tool that dynamically forms user groups to grant access permissions to protected resources;

FIG. 2 is a flowchart describing some of the processing functions associated with dynamically forming user groups with the dynamic profile access control tool shown in FIG. 1;

FIG. 3 is an example of a hierarchical structure diagram that the dynamic profile access control tool of FIG. 1 could be used to dynamically form user groups from; and

FIG. 4 shows a schematic of an exemplary computing environment in which the dynamic profile access control tool shown in FIG. 1 may operate.

### DETAILED DESCRIPTION

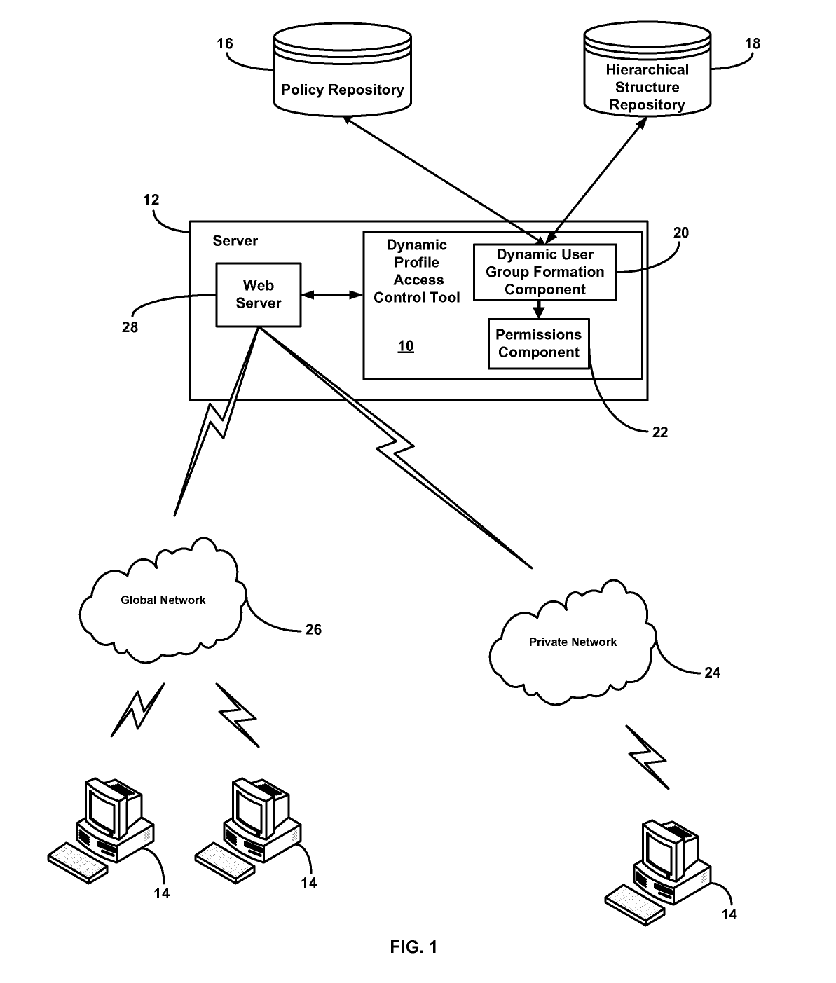

FIG. 1 shows a high-level component architecture diagram of a dynamic profile access control tool 10 that dynamically forms user groups to grant access permissions to protected resources. In the description that follows, the dynamic profile access control tool 10 grants permissions to protected resources in a business organization scenario, but one of ordinary skill in the art will recognize that the principles of this disclosure are suitable for any application where the protection of resources are impacted by hierarchical structures. For the business organization scenario, an illustrative but non exhaustive list of protected resources could include online documents, web contents, proprietary technologies, patent disclosure letter filings, etc. Also, in the description that follows, permissions can mean any of a number of possible actions that one can perform on a resource. An illustrative, but non-limiting, list of permissions includes viewing, editing, adding, deleting, modifying, and administrating privileges.

The dynamic profile access control tool 10 as shown in FIG. 1 is situated in a server 12 and accessed through computing units 14, however, one of ordinary skill in the art will recognize that tool does not have to reside within the server. As shown in FIG. 1, there is a policy repository 16 containing rules that specify access permissions to protected resources within an organization. The policy repository 16 generally stores policies that provide guidelines on what type of access members of a business organization will have to a resource. There are generally several types of policies that may be stored in the policy repository 16. One type of policy is a resource type policy which is a policy that applies to all of the resources of the same type. For example, there may be two types of resources, windows and doors. When a resource type policy is created for windows, then that resource will apply to all windows, but not doors. Another type of policy is an instance type policy which is a policy that only applies to a specific resource. Generally, the policies can be created, removed or updated at any time.

Examples of some resource type policies and instance type policies are as follows:
a. Any users two levels above a scorecard owner and all levels below a scorecard owner can VIEW that user's resources. (Resource type policy).
b. Any users three levels above John Smith and two levels below John Smith can VIEW all of John's resources. (Instance policy)
c. Any user who is one level above a resource owner can APPROVE that resource. (Resource type policy)
   In example a, if Bob Jones owned the scorecard and was a low level manager in his business organization, then his scorecard could be viewed two levels up the hierarchical structure by his manager and his manager's manager and viewed all levels below him such as his direct reports and any people reporting to his direct reports. In example b, if John Smith was a low level manager in his business organization, then his resources could be viewed three levels up the hierarchical structure by his manager, his manager's manager and their manager and viewed two levels below him by his direct reports and any people reporting to his direct reports. In example c, if Francis Flores, a direct report, owns a particular resource such as an expense statement form that she wants to submit for approval, then any user who is one level above Francis such as her manager can approve that expense statement.

In an exemplary embodiment, the policy repository 16 is a database but it should not be limited to only database technologies. One of ordinary skill in the art will recognize that the policy repository 16 can be any data repository such as extensible markup language (XML) files.

Referring back to FIG. 1, there is a hierarchical structure repository 18 that is configured to store a hierarchical structure that describes associations between members in the business organization. In particular, the hierarchical structure shows all of the several levels of an organization arranged in a tree-like structure. One of ordinary skill in the art will recognize that the hierarchical structure repository 18 can take the form of a Lightweight Directory Access Protocol (LDAP) directory which can typically store entries of people and organization units in a tree-like structure, however, any repository such as a database or file can be use with the dynamic profile access control tool.

The dynamic profile access control tool 10 comprises a dynamic user group formation component 20 configured to obtain the policy from the policy repository 16 and the hierarchical structure from the hierarchical structure repository 18 and dynamically form a user group based on the policy and hierarchical structure. After retrieving the policy from the policy repository 16 and the hierarchical structure from the hierarchical structure repository 18, the dynamic user group formation component 20 applies the specifications of the policy to the retrieved hierarchical structure and determines which members in the organization meet the specifications. Members that meet the specifications are used to form the user group. The formation of the users group is dynamic because the dynamic user group formation component 20 is able to pull the policy and compare it against the current hierarchical structure to generate a group of users that shall be granted permissions for a specific resource every time someone makes an access request for a resource. In a static process, the user group is always the same and does not change because it is assumed that all members of the group are known. There would be no need to check for a current hierarchical structure. If one wanted to check for a current hierarchical structure then the user groups would have to be manually changed either adding or deleting names for any changes that may have occurred.

The dynamic profile access control tool 10 also comprises a permissions component 22 that is configured to use the user groups formed by the dynamic user group formation component 20 to grant access permissions to protected resources. As mentioned above, permissions as used in this disclosure vary in scope and can mean allowing members to perform a number of possible actions on a resource such as viewing, editing, adding, deleting, modifying, approving and administrating.

As shown in FIG. 1, computing units 14 can be used to access the dynamic profile access control tool 10. The computing unit 14 can take the form of a personal computer, workstation, notebook computer, hand-held digital computer or a personal digital assistant computer. A web browser can be used to locate and display the dynamic profile access control tool 10 on the computing units 14.

A communication network such as an electronic or wireless network connects the computing units 14 to the dynamic profile access control tool 10. FIG. 1 shows that the computing units 14 may connect to the dynamic profile access control tool 10 through a private network 24 such as an extranet or intranet or a global network 26 such as a WAN (e.g., Internet). As shown in FIG. 1, the dynamic profile access control tool 10 resides in the server 12, which comprises a web server 28 that serves the tool 10 and the policy repository 16 and the hierarchical structure repository 18. However, as mentioned above, the dynamic profile access control tool 10 does not have to be co-resident with the server 12.

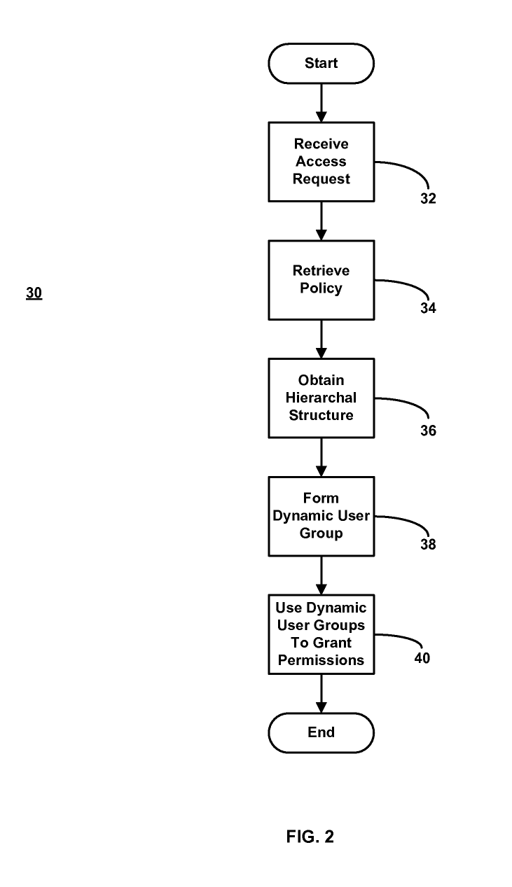

FIG. 2 is a flowchart 30 describing some of the processing functions associated with dynamically forming user groups with the dynamic profile access control tool 10 shown in FIG. 1. At 32, the dynamic profile access control tool receives an access request for a particular resource. Typically, the dynamic profile access control tool will receive an access request when a user logs onto to a particular system that has access control for a particular resource or if someone like an administrator wants to see if a particular person in a user group has permissions for a resource. These are only a few examples of how an access request can arise and one of ordinary skill in the art will recognize that access requests can rise through other instances.

Once the dynamic profile access control tool has received an access request, it will retrieve the policy for the specified resource from the policy repository at 34 that the user is interested in. In addition, the dynamic profile access control tool obtains the hierarchical structure from the hierarchical structure repository at 36. Using the current policy for the specified resource and the current hierarchical structure, the dynamic user group formation component will dynamically form a user group at 38. In particular, the dynamic user group formation component applies the rules of the policy that govern the particular resource to the retrieved hierarchical structure to determine which members in the hierarchy of the organization meet the specifications of the rule. Generally, members that meet the specifications are used to form the user group and people that do not meet the specifications are excluded from the group. The permissions component will treat the dynamically formed user group as a subject and either grant permission or revoke permission to the individual or groups of elements making the request at 40. In particular, the permissions component will grant permission to the resource if the individual or groups of elements making the request is a member of the dynamically formed user group.

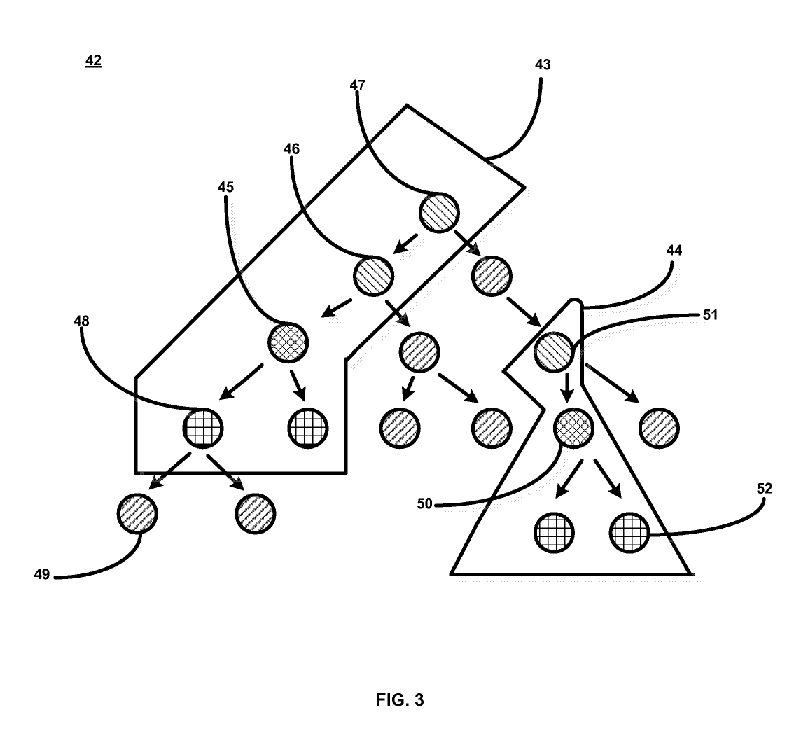

FIG. 3 is an example of a hierarchical structure diagram 42 that the dynamic profile access control tool 10 of FIG. 1 could be used to dynamically form user groups from. In this example, there are five levels in the hierarchy and two policies 43 and 44 associated within this organization. An example of policy 43 for a scorecard could be that people who are three levels above the owner of a scorecard resource and two levels below the owner of the resource can read the resource. People who are one level above the owner of a scorecard can approve that scorecard. If node 45 represented an owner of a scorecard who is at the third level of the organization (i.e., level one starts at the bottom of the organization hierarchy), then nodes 46 and 47 can read the scorecard as well as nodes 48 and 49. If there was another node in the hierarchy above node 47, then that node would also have read permissions because of the specific policy. With regard to approving the scorecard, only node 46 can approve it because it is one level above node 45.

In this example, the dynamic profile access control tool 10 would dynamically form the user groups after retrieving the policy for the scorecard and the hierarchical structure. In particular, the dynamic profile access control tool 10 would ascertain that node 45 is a scorecard owner and based on the policy and hierarchical structure, determine that nodes 46 and 47 can read the scorecard as well as nodes 48 and 49 and node 46 can approve the scorecard. The dynamically formed user group in this example would comprise nodes 46-49 as members.

For policy 44, there would be visibility only one level up and one level down. If node 50 was the owner of a particular resource then only node 51 which is one level above node 50 and node 52 which is one level below node 50 would have visibility or read permissions for the resource. In this example, the dynamic profile access control tool 10 would dynamically form the user group after retrieving this visibility policy and the hierarchical structure. In particular, the dynamic profile access control tool 10 would ascertain that node 50 is an owner and based on the policy and hierarchical structure, determine that nodes 51 and 52 can read the resource. The dynamically formed user group in this example would comprise nodes 51-52.

A benefit associated with the approach described herein is that a consistent business rule based access model is applied to better govern access to critical business information. This is especially important in the current business climate where organizations are refocused on better management of information, as well as ensuring that their competitive assets and knowledge are not compromised. As such organizations go through their natural evolution they are not forced to constantly re-evaluate membership rules since they are generically applied based on the business rules and dynamic grouping. This will also decrease complexity as it relates to individual policies as the asset can be leveraged in multiple compliance and business related venues where rules are common as to transparency and individual access. Another benefit with this approach is that allows for flexibility of access assignment by applying standard and inverted hierarchal constraints on access and transparency.

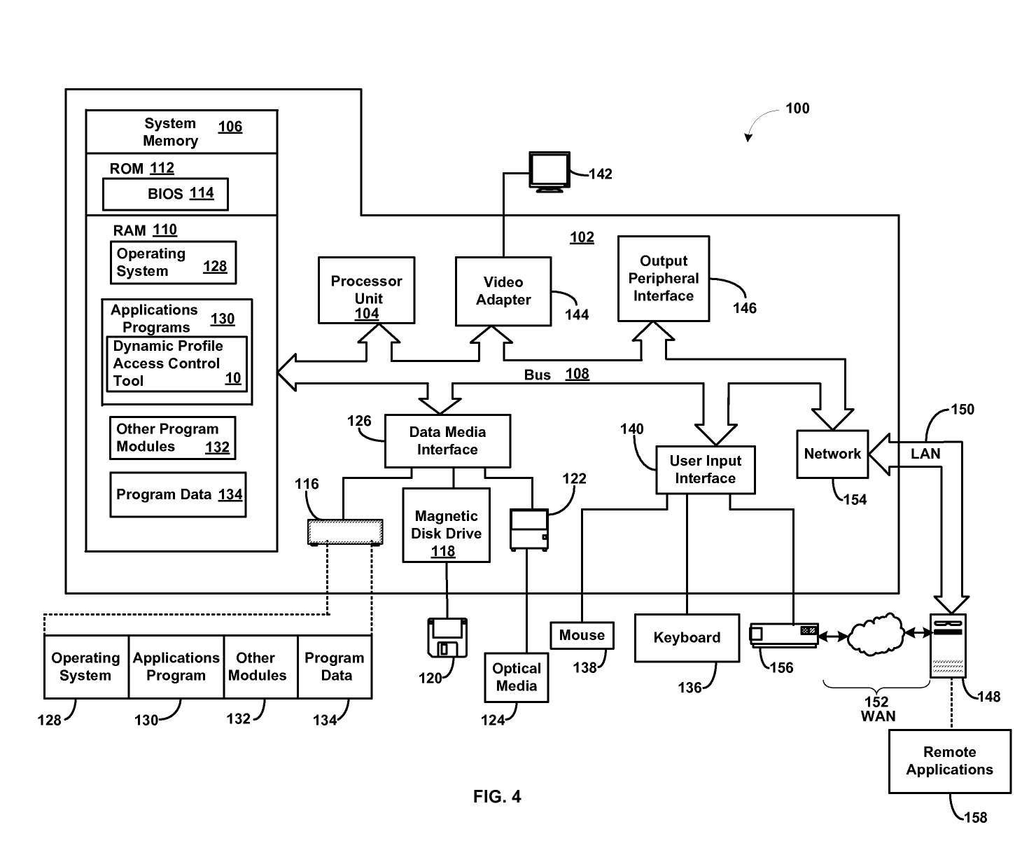

FIG. 4 shows a schematic of an exemplary computing environment 100 in which the dynamic profile access control tool 10 shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 4.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 4, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 4, the system memory 106 includes computer readable media in the form of volatile memory, such as random access memory (RAM) 110, and/or non-volatile memory, such as read only memory (ROM) 112. A basic input/output system (BIOS) 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 4 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130 (e.g., dynamic profile access control tool 10), other program modules 132, and program data 134.

Each of the operating system 128, one or more application programs 130 other program modules 132, and program data 134 or some combination thereof, may include an implementation of the dynamic profile access control tool 10 of FIG. 1. Specifically, each may include an implementation of the dynamic profile access control tool 10 which: (a) obtains a policy that specifies access permissions to a protected resource within an organization; (b) retrieves a hierarchical structure that describes associations between members in the organization; (c) dynamically forms a user group based on the obtained policy and retrieved hierarchical structure; and (d) uses the dynamically formed user group to grant access permissions to the protected resource.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 4 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 4 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure, an approach for providing dynamic profile access control. While the disclosure has been particularly shown and described in conjunction with a preferred embodiment thereof, it will be appreciated that variations and modifications can be effected by a person of ordinary skill in the art without departing from the scope of the disclosure.

In another embodiment, this disclosure provides a business method that performs the process steps of the invention on a subscription, advertising, and/or fee basis. That is, a service provider could offer to provide dynamic profile access control within a computer system. In this case, the service provider can create, deploy, maintain, support, etc., a dynamic profile access control tool, such as tool 10 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, this disclosure provides a method for using dynamic profile access control within a computer system to protect specified resources. In this case, a dynamic profile access control tool, such as tool 10 (FIG. 1), can be provided and one or more systems for performing the process steps of the disclosure can be obtained and deployed to the framework. To this extent, the deployment of a system can comprise one or more of (1) installing program code on a computing device, such as a computer system, from a computer-readable medium; (2) adding one or more computing devices to the framework; and (3) incorporating and/or modifying one or more existing systems of the framework to enable the framework to perform the process steps of the invention.

What is claimed is:

1. A method for providing dynamic profile access control, comprising:
obtaining a policy that specifies access permissions to a protected resource within an organization;
retrieving a hierarchical structure that describes associations between members in the organization;
dynamically forming a user group based on the obtained policy and retrieved hierarchical structure; and
using the dynamically formed user group to grant access permissions to the protected resource.

2. The method according to claim 1, wherein the obtaining of a policy comprises retrieving the policy from a repository.

3. The method according to claim 1, wherein the retrieving of a hierarchical structure comprises obtaining the policy from a repository.

4. The method according to claim 1, wherein the dynamically forming of a user group comprises applying the specifications of the policy to the retrieved hierarchical structure and determining which members in the organization meet the specifications, wherein members that meet the specifications are used to form the user group.

5. The method according to claim 1, further comprising receiving an access request for the protected resource.

6. A dynamic profile access control tool for use in a computer system that controls access to a protected resource, comprising:
a policy repository containing rules that specify access permissions to the protected resource within an organization;
hierarchical structure repository that is configured to store a hierarchical structure that describes associations between members in the organization;
a dynamic user group formation component configured to obtain the policy from the policy repository and the hierarchical structure from the hierarchical structure repository and dynamically form a user group based on the policy and hierarchical structure; and
a permissions component configured to use the dynamic user group to grant access permissions to the protected resource.

7. The tool according to claim 6, wherein the dynamic user group formation component is further configured to apply the specifications of the policy to the retrieved hierarchical structure and determine which members in the organization meet the specifications, wherein members that meet the specifications are used to form the user group.

8. A computer-readable medium storing computer instructions for providing dynamic profile access control within a computer system that controls access to a protected resource, the computer instructions comprising:
obtaining a policy that specifies access permissions to a protected resource within an organization;
retrieving a hierarchical structure that describes associations between members in the organization;
dynamically forming a user group based on the obtained policy and retrieved hierarchical structure; and
using the dynamically formed user group to grant access permissions to the protected resource.

9. The computer-readable medium according to claim 8, wherein the retrieving of a hierarchical structure comprises instructions for obtaining the policy from a repository.

10. The computer-readable medium according to claim 8, wherein the obtaining of a policy comprises instructions for retrieving the policy from a repository.

11. The computer-readable medium according to claim 8, wherein the dynamically forming of a user group comprises instructions for applying the specifications of the policy to the retrieved hierarchical structure and instructions for determining which members in the organization meet the specifications, wherein members that meet the specifications are used to form the user group.

12. The computer-readable medium according to claim 8, further comprising instructions for receiving an access request for the protected resource.
